(19) United States
(12) Patent Application Publication
(10) Pub. No.: US 2016/0098245 A1
(43) Pub. Date: Apr. 7, 2016

(54) SYSTEMS AND METHODS FOR ENHANCING TELECOMMUNICATIONS SECURITY

(71) Applicant: Brian Penny, Peekskill, NY (US)

(72) Inventor: Brian Penny, Peekskill, NY (US)

(21) Appl. No.: 14/847,531

(22) Filed: Sep. 8, 2015

Related U.S. Application Data
(60) Provisional application No. 62/046,503, filed on Sep. 5, 2014.

(51) Int. Cl. G06F 3/16; G10K 11/175

(52) U.S. Cl. CPC G06F 3/165; G10K 11/175

(57) ABSTRACT

The present invention provides a method and system for securing audio data. The method includes receiving audio input signals from an input port, receiving at least one noise signal from a noise source, generating encoded audio by a signal encoder encoding the audio input signals with the at least one noise signal, decoding the encoded audio by a signal decoder playing the encoded audio with an out-of-phase version of the at least one noise signal, and playing by an audio output component the decoded audio.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The disclosed invention relates generally to systems and methods for securing transmissions. More specifically, embodiments of the disclosed invention are directed towards systems and methods for securing transmissions, such as audio transmissions, by utilizing a masking noise mechanism. Given the expanded use of audio communications, such as cellular communications, and insecurity of networks there currently exists a need in the art of a method and system of securing audio communications between two devices.

### SUMMARY OF THE INVENTION

The present invention provides a method and system for securing audio data. The method includes receiving audio input signals from an input port, receiving at least one noise signal from a noise source, generating encoded audio by a signal encoder encoding the audio input signals with the at least one noise signal, decoding the encoded audio by a signal decoder playing the encoded audio with an out-of-phase version of the at least one noise signal, and playing by an audio output component the decoded audio.

The noise source may include white noise and music audio content. In one embodiment, receiving the at least one noise signal further comprises accessing a plurality of files stored on a storage medium. According to another embodiment generating the encoded audio further comprises cueing the at least one noise signal by identifying a start signal in the at least one noise signal to begin the encoding. Generating the encoded audio may further comprise encoding the audio input signals with the at least one noise signal by mixing the cued noise with the audio input signals. In a further embodiment, generating the encoded audio further comprises mixing the cued noise with the audio input signals by combining waveforms of the audio input signals and the at least one noise signal into a single, mixed waveform.

Generating the encoded audio may also further comprise encoding a delay associated with the start signal in the encoded audio. In an exemplary embodiment, generating the encoded audio further comprises encoding a delay associated with the start signal into a first block of the audio input signal. The method may further comprise receiving and buffering the audio input signals using an input buffer. The encoded audio and a delay associated with the start signal may be transmitted to a recipient device.

According to one embodiment, the system includes an input port that receives audio input signals, a noise source containing at least one noise signal, a signal encoder that generates encoded audio by encoding the audio input signals with the at least one noise signal, a signal decoder that decodes the encoded audio by playing the encoded audio with an out-of-phase version of the at least one noise signal, and an output port that outputs the decoded audio.

The noise source may include white noise and music audio content. In one embodiment, the noise source is operable to access a plurality of files stored on a storage medium. The signal encoder is operable to cue the at least one noise signal by identifying a start signal in the at least one noise signal to begin the encoding. In a further embodiment, the signal encoder is further operable to encode the audio input signals with the at least one noise signal by mixing the cued noise with the audio input signals. The signal encoder may be further operable to mix the cued noise with the audio input signals by combining waveforms of the audio input signals and the at least one noise signal into a single, mixed waveform.

According to another embodiment, the signal encoder is further operable to encode a delay associated with the start signal in the encoded audio. One embodiment includes the signal encoder is further operable to encode a delay associated with the start signal into a first block of the audio input signal. The system may further comprise an input buffer that receives and buffers the audio input signals. The system may also further comprise a network controller that transmits the encoded audio and a delay associated with the start signal to a recipient device.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a telecommunications device according to one embodiment of the disclosed invention;

FIG. 2 illustrates a system for securing audio transmissions according to one embodiment of the disclosed invention;

FIG. 3 illustrates a method for securing audio transmissions according to one embodiment of the disclosed invention; and

FIG. 4 illustrates a method for playing secured audio transmissions according to one embodiment of the disclosed invention.

### DETAILED DESCRIPTION OF THE INVENTION

In the following description of the embodiments of the disclosure, reference is made to the accompanying drawings that form a part hereof, and in which is shown by way of illustration exemplary embodiments in which the invention may be practiced. It is to be understood that other embodiments may be utilized and structural changes may be made without departing from the scope of the disclosed invention.

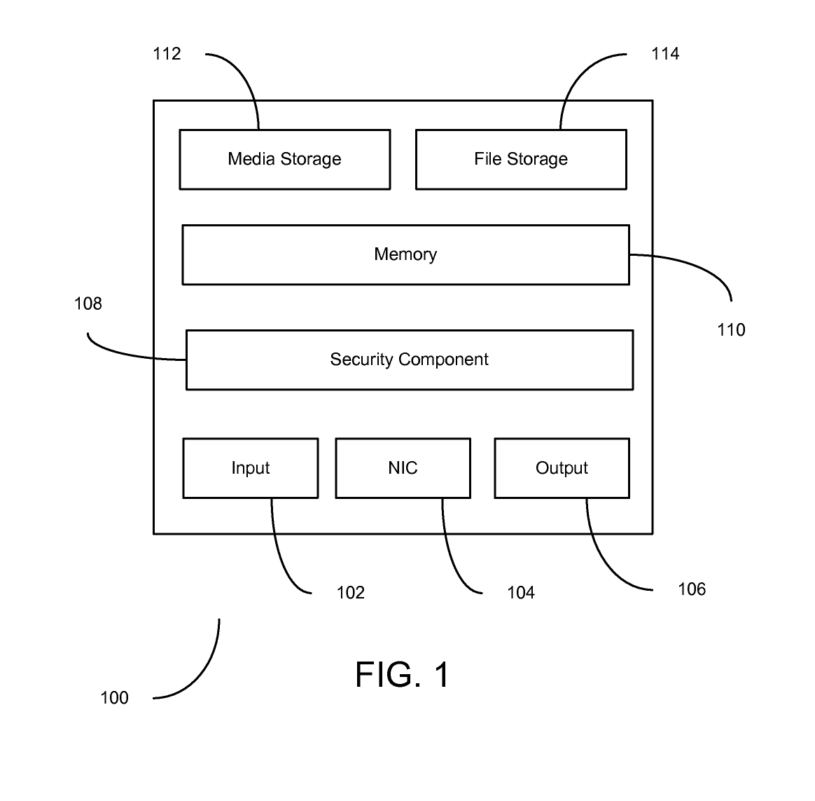

FIG. 1 illustrates a telecommunications device according to one embodiment of the disclosed invention. As the embodiment of FIG. 1 illustrates, a device 100 comprises a plurality of components 102, 104, 106, 108, 110, 112, and 114. In one embodiment, the device 100 may comprise a mobile computing device such as a mobile phone, smart phone, tablet, or laptop computer. In alternative embodiments, the device 100 may comprise any other device operative to facilitate voice or data communications including, but not limited to, a desktop computer or VoIP telephone.

Device 100 contains an input component 102 and output component 106. In one embodiment, input and output components 102 and 106 may allow for voice input and audio output to the device 100. To this end, input component 102 may comprise a microphone input or line-in input. Likewise, in the illustrated embodiment, output component 106 may comprise any suitable device or subsystem to facilitate audio playback including, but not limited to, a speaker or line out. Although not illustrated, both input and output components 102 and 106 may include various circuitry in order to provide the input and output functionality described previously such as amplifiers, filters, and other circuitry. Device 100 additionally includes a network interface component 104. In one embodiment, network interface component (“NIC”) 104 may comprise a plurality of subcomponents to facilitate network communications over a network such as a cellular network. Alternatively, or in conjunction, with the foregoing, the network interface component 104 may facilitate communications over other networks such as Ethernet-based networks or WiFi networks.

Device 100 further comprises media storage 112 and file storage 114. In one embodiment, media storage 112 and file storage 114 may comprise separate storage devices such as non-volatile memory cards (“SD Cards”), hard disk storage, flash-based storage, or a combination thereof. Alternatively, media storage 112 and file storage 114 may reside on a single storage device. In the illustrated embodiment, media storage 112 may store multimedia associated with the device such as audio, video, photographs, and other multimedia. In the illustrated embodiment, file storage 114 may store data used in the operation of the device 100. For example, file storage 114 may store an operating system, device drivers, application software, library files, and application files. Device 100 additionally comprises a memory 110. In one embodiment, memory 110 may comprise a volatile memory device.

Device 100 additionally comprises a security component 108. In the illustrated embodiment security component 108 comprises circuitry and/or software for securing communications transferred via NIC 104. In the illustrated embodiment, security component 108 receives input audio from input component 102 and may transmit secure audio via NIC 104. Furthermore, security component 108 may receive secure audio from NIC 104 and output insecure audio via output component 106. Security component 108 may secure and unsecure audio according to methods describe more fully herein.

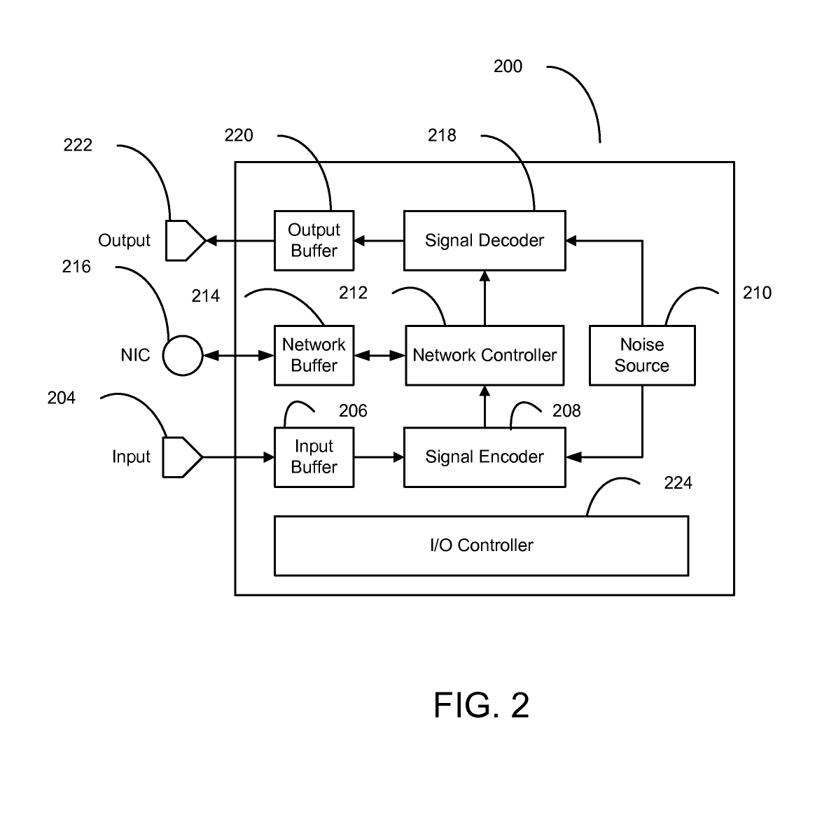

FIG. 2 illustrates a system for securing audio transmissions according to one embodiment of the disclosed invention. In the illustrated embodiment, system 200 contains an input/output (“I/O”) controller 224. In one embodiment, I/O controller 224 may contain circuitry and/or software for controlling the operation of the system 200.

In the illustrated embodiment, a system 200 comprises an input port 204. As discussed, an input port 204 may comprise a line in or microphone input jack and may allow for input via tip-sleeve (“TS”) or tip-ring-sleeve (“TRS”) connectors. Alternatively, input port 204 may comprise a built-in microphone such as those found in cellular telephones and tablet devices. Input port 204 is communicatively coupled to an input buffer 206. In the illustrated embodiment, input buffer 206 may temporarily store incoming audio data to account for latency in data transfer. In alternative embodiments, input port 204 may be directly connected to signal encoder 208 and bypass the input buffer 206 in scenarios where low latency communications are guaranteed and/or buffering is infeasible.

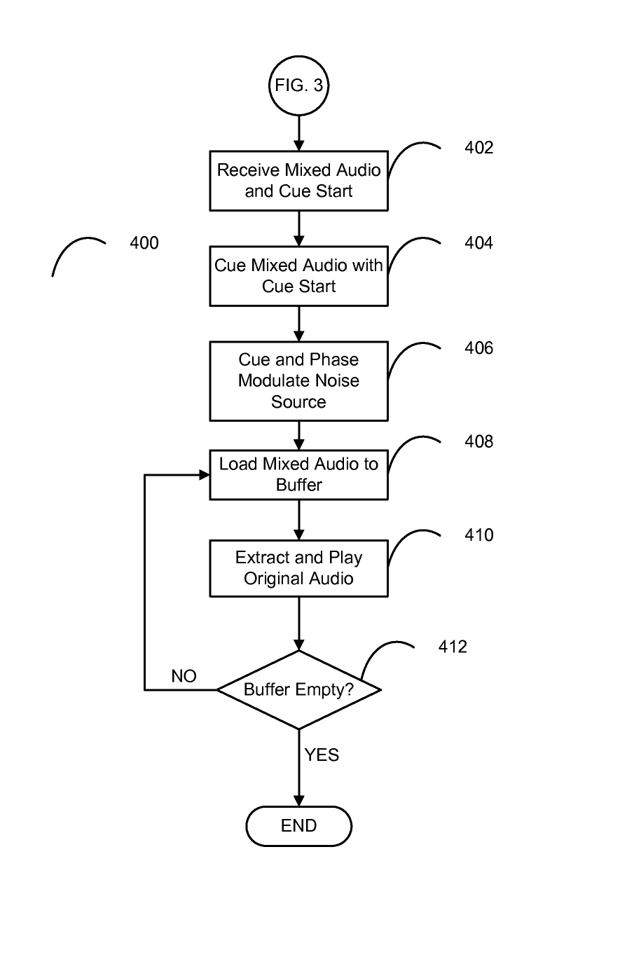

A signal encoder 208 receives audio data from the input buffer 206, encodes the audio data, and provides the encoded data to network controller 212. In the illustrated embodiment, a signal encoder 208 may be additionally communicatively coupled to noise source 210. In one embodiment, noise source 210 may generate or provide storage of noise audio data such as white noise and/or musical data. In one embodiment, signal encoder 208 is operative to retrieve noise from the noise source 210 by selecting a predetermined noise or by selecting a user-defined noise. After retrieving the noise, the signal encoder 208 selects a cue start position for the retrieved noise. The signal encoder 208 then encodes the input signal by combining the input signal with the cued noise source to form a single, encoded noise source (secured audio data). Encoding input signals is discussed more fully with respect to FIG. 3.

Signal encoder 208 transmits the encoded audio to a network controller 212, the controller 212 operative to transmit data to network buffer 214. In the illustrated embodiment, network controller 212 may comprise any standard network interface card or circuitry. In the illustrated embodiment, the network controller 212 is operative to transmit the encoded audio data across a network (not shown) such as the Internet. Network controller 212 may be configured to work with a variety of networks such as Ethernet networks, cellular networks, etc. Network buffer 214 is operative to temporarily buffer outgoing and incoming audio transmitted and received, respectively, from network interface component 216.

Network controller 212 is further communicatively coupled to signal decoder 218. In the illustrated embodiment, signal decoder 218 is operative to receive encoded audio data from the network (not shown) via the network controller 212. For example, signal decoder 218 may receive the encoded data from a second system containing similar components to that of system 100. Signal decoder 218 is communicatively coupled to noise source 210 and, in response to receiving encoded audio, may retrieve noise from the noise source 210. In order to decode the encoded audio, the signal decoder may start playing an out-of-phase version of the noise at the identified cue start in order to extract the original audio. Signal decoder 218 is operative to transmit unsecured (decoded) audio to output buffer 220 for temporary storage prior to output the unsecured audio to output port 222.

FIG. 3 illustrates a method for securing audio transmissions according to one embodiment of the disclosed invention. In the illustrated embodiment, a method 300 includes loading a noise source, step 302. In one embodiment, a noise source may comprise white noise, music, or any other audio content. Loading a noise source may comprise accessing a plurality of files stored on a storage medium and opening said files.

The method 300 then cues the noise source, step 304. In the illustrated embodiment, cueing a noise source may comprise a signal encoder identifying a start signal for the noise source to begin encoding audio. The start signal may be received at the input port to turn on the noise element and to add a delay in the system (e.g., latency) to the start time of the encoding. The delay may include data transmission time, response and processing time of the system. The method 300 then receives and buffers an input signal (of a given audio sample, recording session, track or file) from an input port, step 306 and begins to mix (encoding by signal encoder) cued noise with the input signal, step 308. In the illustrated embodiment, mixing an input signal with a noise source may comprise combining the waveforms of the two audio sources into a single, mixed waveform (encoded audio data). In one embodiment, mixing may include various filtering techniques in order to ensure the fidelity of the encoded signal.

The method 300 continues to encode an input signal onto the cued noise until an input buffer is empty 310. Upon determining that the input buffer is empty, the method 300 transmits the mixed audio and the cue start information via a network controller, step 412. In one embodiment, the method 300 may encode the cue start information onto the encoded audio signal. For example, the method 300 may include the cue start in the first block of the audio data stream. Alternatively, the method 300 may transmit the cue start independently (e.g., prior to transmitting the encoded audio) in order to avoid latency issues. In some embodiments, the method 300 may additionally transmit both the mixed audio and the original audio simultaneously. Thus, the method 300 may transmit the original noise source and the encoded noise source to a recipient device obviating the requirement of the recipient device to pre-store the utilized noise source.

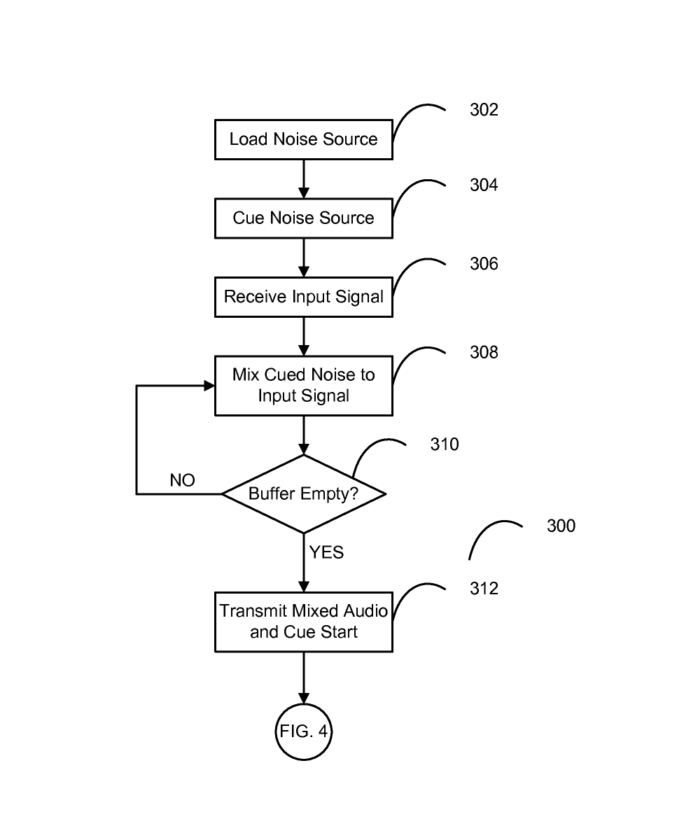

FIG. 4 illustrates a method for playing secured audio transmissions according to one embodiment of the disclosed invention. As the embodiment of FIG. 4 illustrates, a method 400 includes receiving the mixed audio and cue start from a network interface or controller, step 402. Upon receipt of the mixed audio, the method 400 cues the mixed audio using the received cue start, step 404. The method 400 additionally cues an out-of-phase version of an underlying noise source in the mixed audio, step 406. As discussed above, the method 400 may utilize a pre-stored noise source that is shared by both the sender and the receiver. Alternatively, the method 400 may receive the original noise source as part of the receiving the mixed audio and cue start.

The method 400 then loads the mixed audio into a buffer for processing by a signal decoder, step 408. In one embodiment, the method 400 may additionally load the original noise source into a separate buffer for parallel processing. After loading the mixed audio, the method 400 extracts and plays the original audio from the mixed audio, step 410, until the buffer is empty, step 412. In one embodiment, extracting the original audio may comprise playing the out-of-phase version of the noise source simultaneous with the encoded noise source. By doing so, the method 400 effectively cancels out the added noise source, leaving the original audio intact. In alternative embodiments, the decoding process may be performed without the physical playing of the audio, that is, the decoded audio may be stored or saved locally for later retrieval.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A system for securing audio data, the system comprising:
an input port that receives audio input signals;
a noise source containing at least one noise signal;
a signal encoder that generates encoded audio by encoding the audio input signals with the at least one noise signal;
a signal decoder that decodes the encoded audio by playing the encoded audio with an out-of-phase version of the at least one noise signal; and
an output port that outputs the decoded audio.

2. The system of claim 1 wherein the noise source includes white noise and music audio content.

3. The system of claim 1 wherein the noise source is operable to access a plurality of files stored on a storage medium.

4. The system of claim 1 wherein the signal encoder is operable to cue the at least one noise signal by identifying a start signal in the at least one noise signal to begin the encoding.

5. The system of claim 4 wherein the signal encoder is further operable to encode the audio input signals with the at least one noise signal by mixing the cued noise with the audio input signals.

6. The system of claim 5 wherein the signal encoder is further operable to mix the cued noise with the audio input signals by combining waveforms of the audio input signals and the at least one noise signal into a single, mixed waveform.

7. The system of claim 4 wherein the signal encoder is further operable to encode a delay associated with the start signal in the encoded audio.

8. The system of claim 4 wherein the signal encoder is further operable to encode a delay associated with the start signal into a first block of the audio input signal.

9. The system of claim 1 further comprising an input buffer that receives and buffers the audio input signals.

10. The system of claim 1 further comprising a network controller that transmits the encoded audio and a delay associated with the start signal to a recipient device.

11. A method for securing audio data, the method comprising:
receiving audio input signals from an input port;
receiving at least one noise signal from a noise source;
generating encoded audio by a signal encoder encoding the audio input signals with the at least one noise signal;
decoding the encoded audio by a signal decoder playing the encoded audio with an out-of-phase version of the at least one noise signal; and
playing by an audio output component the decoded audio.

12. The method of claim 11 wherein the noise source includes white noise and music audio content.

13. The method of claim 11 wherein receiving the at least one noise signal further comprises accessing a plurality of files stored on a storage medium.

14. The method of claim 11 wherein generating the encoded audio further comprises cueing the at least one noise signal by identifying a start signal in the at least one noise signal to begin the encoding.

15. The method of claim 14 wherein generating the encoded audio further comprises encoding the audio input signals with the at least one noise signal by mixing the cued noise with the audio input signals.

16. The method of claim 15 wherein generating the encoded audio further comprises mixing the cued noise with the audio input signals by combining waveforms of the audio input signals and the at least one noise signal into a single, mixed waveform.

17. The method of claim 14 wherein generating the encoded audio further comprises encoding a delay associated with the start signal in the encoded audio.

18. The method of claim 14 wherein generating the encoded audio further comprises encoding a delay associated with the start signal into a first block of the audio input signal.

19. The method of claim 11 further comprising receiving and buffering the audio input signals using an input buffer.

20. The method of claim 11 further comprising transmitting the encoded audio and a delay associated with the start signal to a receipt device.
